(19) United States
(12) Patent Application Publication
(10) Pub. No.: US 2019/0370689 A1
(43) Pub. Date: Dec. 5, 2019

(54) LEARNING DATA ACQUIRING APPARATUS AND METHOD, PROGRAM, AND STORING MEDIUM

(71) Applicant: OMRON Corporation, Kyoto-shi, KYOTO (JP)

(72) Inventors: Tanichi ANDO, Komaki, Aichi (JP); Keitaku KANEMOTO, Kyoto-shi, KYOTO (JP)

(73) Assignee: OMRON Corporation, Kyoto-shi, KYOTO (JP)

(21) Appl. No.: 16/462,024

(22) PCT Filed: Feb. 24, 2017
(86) PCT No.: PCT/IB2017/051076

§ 371 Date: May 17, 2019

(51) Int. Cl. G06N 20/00; G06K 9/62

(52) U.S. Cl. CPC G06N 20/00; G06K 9/6256

(57) ABSTRACT

The disclosure relates to a learning data acquiring apparatus and method, program, and storing medium. The learning data acquiring apparatus is configured to acquire learning data about learning objects for machine learning, and includes: a learning data acquiring portion, acquiring the learning data about the learning objects according to learning condition information, the learning condition information being information generated according to commission information of user commissioned learning; and a modification instructing portion, modifying setting of the learning data acquiring portion for acquiring the learning data according to the learning condition information.

### TECHNICAL FIELD

The present invention relates to the field of deep learning, and more particularly to a learning data acquiring apparatus and method, program, and storing medium for acquiring learning data about a learning object for machine learning.

### BACKGROUND ART

In recent years, artificial intelligence (AI) technologies represented by deep learning make constant progresses, and technologies such as classifying and predicting an analysis object based on input data such as a camera images and sensor data start to be popularized. By using such AI technology as the deep learning technology, a machine may obtain capabilities such as classifying the analysis objects through automatic learning.

With the rapid development of the AI technology, capabilities that may be obtained by the machine as a learning result are more and more broad. Consequently, more users wish to use learning such as the deep learning technology to train machines for obtaining desired capabilities.

Recently, a device (e.g. the classification machine in Patent document 1) capable of classifying or identifying objects involved in images by means of machine learning and using the image data as learning data has been proposed.

### PRIOR ART DOCUMENTS

### Patent Documents

Patent document 1: JP laid-open publication No. 2016-40650

### SUMMARY OF THE INVENTION

### Technical Problems to be Solved

When the deep learning is performed, the learning should be performed based on a lot of learning data. Generally, if there are less learning data for learning, the scope which may be coped with by the obtained capability becomes narrow. However, since the learning of the deep learning type costs a lot of time and system resources, the data cannot be added too many. Therefore, common users cannot decide what type of learning data should be prepared or to what degree the learning data should be prepared so that the desired capability may be obtained. There is the problem of waste of time and efforts in the preparation of the learning data.

For example, a learning machine (classification machine) capable of performing high-precision classification of images is disclosed in the above Patent document 1. In order to constitute such a learning machine, it is required to collect vast and various learning data, and input those learning data to the learning machine according to the capabilities to be obtained by the learning machine as required. However, the collection and input of those vast and various learning data shall be completed manually, thereby wasting time and manpower.

Particularly, when collecting the learning data, configurations of an object operating apparatus for performing operation on the learning objects, a data collecting apparatus collecting data from the learning objects and so on might need to be modified, and this brings great burden to users.

Therefore, automation of collecting the learning data becomes extremely important.

One of the technical problems to be solved in the present invention is to provide an apparatus, method, program and storing medium which may automatically or semi-automatically acquire learning data.

### Solutions to Technical Problems

According to an embodiment of the present invention, a learning data acquiring apparatus is provided, for acquiring learning data about learning objects for machine learning, and may comprise: a learning data acquiring portion, acquiring the learning data about the learning objects according to learning condition information, the learning condition information being information generated according to commission information of user commissioned learning; and a modification instructing portion, modifying setting of the learning data acquiring portion for acquiring the learning data according to the learning condition information.

Further, the learning data acquiring portion may comprise: an operating portion, controlling an object operating apparatus performing an operation on the learning objects or a data collecting apparatus collecting data from the learning objects; and an input and output portion, receiving the data collected by the data collecting apparatus, and outputting the learning data generated according to the data.

In the above learning data acquiring apparatus, the learning condition information may include operation information about the object operating apparatus or the data collecting apparatus, and according to the operation information, the modification instructing portion may modify the setting for operating the object operating apparatus or the data collecting apparatus by the operating portion.

In the above learning data acquiring apparatus, the learning condition information includes operation information about the object operating apparatus or the data collecting apparatus, the input and output portion further may receive state information about the object operating apparatus or the data collecting apparatus, and according to the operation information and the state information, the modification instructing portion may modify the setting for operating the object operating apparatus or the data collecting apparatus by the operating portion.

Further, the object operating apparatus may comprise a first operating portion and a second operating portion, and both the first operating portion and the second operating portion are capable of operating the learning objects, wherein the modification instructing portion may modify the setting for operating the object operating apparatus by the operating portion, so that using the first operating portion to operate the learning objects is switched to using the second operating portion to operate the learning objects.

Similarly, in the above learning data acquiring apparatus, the data collecting apparatus may comprise a first collecting portion and a second collecting portion, both the first collecting portion and the second collecting portion are capable of collecting data from the learning objects, wherein the modification instructing portion may modify the setting for operating the data collecting apparatus by the operating portion, so that using the first collecting portion to collect the data is switched to using the second collecting portion to collect the data.

Similarly, in the above learning data acquiring apparatus, the data collecting apparatus may comprise a first collecting portion and a second collecting portion, both the first collecting portion and the second collecting portion are capable of collecting data from the learning objects, and the first collecting portion and the second collecting portion perform an initialization operation of at least one selected from charging, preparing a storage space or setting collection parameters before collecting data from the learning objects, wherein the modification instructing portion may modify the setting for operating the data collecting apparatus by the operating portion, so that an initialization operation of the first collecting portion is switched to an initialization operation of the second collecting portion.

Further, the data collecting apparatus may provide collected data to the input and output portion in one of a first communicating manner and a second communicating manner, and the modification instructing portion may modify the setting of the learning data acquiring portion, so that using the first communicating manner is switched to using the second communication manner.

In the above learning data acquiring apparatus, further, the learning data acquiring portion further may comprise: a managing portion, managing the operating portion and the input and output portion, the learning condition information includes a first learning condition information and a second learning condition information, and the modification instructing portion may modify the setting of the managing portion, so that acquiring the learning data according to the first learning condition information is switched to acquiring the learning data according to the second learning condition information.

In the above learning data acquiring apparatus, further, the learning data acquiring portion may further comprise: a managing portion, managing the operating portion and the input and output portion, the learning condition information includes information of programs for acquiring the learning data, and the programs include a first program and a second program, and the modification instructing portion may modify the setting of the managing portion, so that using the first program to acquire the learning data is switched to using the second program to acquire the learning data.

Further, the above learning data acquiring apparatus may further comprise: a learning condition information generating portion, receiving from outside the learning condition information or generating the learning condition information according to the commission information, and sending the learning condition information to the learning data acquiring portion and the modification instructing portion.

Further, the above learning data acquiring apparatus may further comprise: a learning data storing portion, storing the learning data.

According to another embodiment of the present invention, a learning data acquiring method is provided for acquiring learning data about learning objects for machine learning, and it may comprise: acquiring the learning data about the learning objects according to learning condition information, the learning condition information being information generated according to commission information of user commissioned learning; and modifying setting for acquiring the learning data according to the learning condition information.

Further, acquiring the learning data about the learning objects may comprise: controlling an object operating apparatus performing an operation on the learning objects or a data collecting apparatus collecting data from the learning objects; and receiving the data collected from the data collecting apparatus, and outputting the learning data generated according to the data.

In the above learning data acquiring method, the learning condition information may include operation information about the object operating apparatus or the data collecting apparatus, and modifying the setting for acquiring the learning data may comprise: according to the operation information, modifying the setting for operating the object operating apparatus or the data collecting apparatus.

Alternatively, in the above learning data acquiring method, the learning condition information may include operation information about the object operating apparatus or the data collecting apparatus, state information about the object operating apparatus or the data collecting apparatus being received, wherein according to the operation information and the state information, modifying the setting for operating the object operating apparatus or the data collecting apparatus.

Further, the object operating apparatus may comprise a first operating portion and a second operating portion, and both the first operating portion and the second operating portion are capable of operating the learning objects, wherein modifying the setting for operating the object operating apparatus may comprise: switching using the first operating portion to operate the learning objects to using the second operating portion to operate the learning objects.

Similarly, the data collecting apparatus may comprise a first collecting portion and a second collecting portion, both the first collecting portion and the second collecting portion are capable of collecting data from the learning objects, wherein modifying the setting for operating the data collecting apparatus may comprise: switching using the first collecting portion to collect the data to using the second collecting portion to collect the data.

Similarly, the data collecting apparatus may comprise a first collecting portion and a second collecting portion, both the first collecting portion and the second collecting portion are capable of collecting data from the learning object, and the first collecting portion and the second collecting portion perform an initialization operation of at least one selected from charging, preparing a storage space or setting collection parameters before collecting data from the learning objects, wherein modifying the setting for operating the data collecting apparatus may comprise: switching an initialization operation of the first collecting portion to an initialization operation of the second collecting portion.

Further, the above learning data acquiring method may further comprise: receiving the collected data from the data collecting apparatus in one of a first communicating manner and a second communicating manner, wherein modifying the setting for operating the data collecting apparatus may comprise: switching using the first communicating manner to using the second communication manner.

Further, the above learning data acquiring method may further comprise: the learning condition information may include a first learning condition information and a second learning condition information, and modifying the setting for acquiring the learning data may comprise: switching acquiring the learning data according to the first learning condition information to acquiring the learning data according to the second learning condition information.

In the above learning data acquiring method, the learning condition information may include information of programs for acquiring the learning data, and the programs include a first program and a second program, wherein modifying the setting about acquiring the learning data may comprise: switching using the first program to acquire the learning data to using the second program to acquire the learning data.

Further, the above learning data acquiring method may further comprise: receiving the learning condition information; or generating the learning condition information according to the commission information.

Further, the above learning data acquiring method may further comprise: storing the learning data.

According to another embodiment of the present invention, a program is provided, for acquiring learning data about learning objects for machine learning, and it may enable a processor to execute the above learning data acquiring method.

According to another embodiment of the present invention, a storing medium is provided, and the storing medium may store the above program.

### Effects of the Invention

The learning data acquiring apparatus and method, program, and storing medium according to the embodiments of the present invention may modify the setting for acquiring the learning data according to the learning condition information, so as to be capable of automatically configuring the object operating apparatus, the data collecting apparatus, etc. during the process of acquiring the learning data, and greatly reduce the user's burden.

Moreover, compared with the user manually configuring or modifying various apparatuses related to acquiring the learning data, the learning data acquiring apparatus or method according to the embodiments of the present invention may improve the configuration accuracy, improve the learning data quality, and avoid man-made errors which may occur in the modifying process. Besides, the learning data acquiring apparatus or method according to the embodiments of the present invention may save the system resources of the local computer or the server, and improve the learning data acquiring efficiency.

### BRIEF DESCRIPTION OF DRAWINGS

The drawings illustrated herein constitute a portion of the description for further understanding of the present invention. The illustrative examples of the present invention and description thereof are used for explaining the present invention, and do not constitute inappropriate limitation to the present invention. In the drawings,

FIG. 1 is a schematic view showing a PC as hardware construction realizing a learning data acquiring apparatus according to an illustrative embodiment of the present invention;

FIG. 2 is a block diagram showing functional modules of a learning data acquiring apparatus according to an illustrative embodiment of the present invention;

FIG. 3 is a block diagram showing functional modules of an object operating apparatus according to an illustrative embodiment of the present invention;

FIG. 4 is a block diagram showing functional modules of a learning data acquiring portion comprised in a learning data acquiring apparatus according to an illustrative embodiment of the present invention;

FIG. 5 is a flow chart showing a learning data acquiring method according to an illustrative embodiment of the present invention;

FIG. 6 is a block diagram showing functional modules of a first application example of a learning data acquiring apparatus according to an illustrative embodiment of the present invention;

FIG. 7 is a flow chart of one example of a learning data acquiring method of a first application example;

FIG. 8 is a schematic view showing one example of performing deep learning using learning data acquired with a learning data acquiring method according to an illustrative embodiment of the present invention;

FIG. 9 is a block diagram showing functional modules of a second application example of a learning data acquiring apparatus according to an illustrative embodiment of the present invention; and

FIG. 10 is a flow chart of one example of a learning data acquiring method of a second application example.

### EMBODIMENTS FOR CARRYING OUT THE INVENTION

In order to make the person skilled in the art better understand the present invention, below the embodiments of the present invention will be described clearly and completely in conjunction with figures of the present invention. Apparently, some but not all of embodiments of the present invention are described. Based on the embodiments of the present invention, all the other embodiments, which a person skilled in the art obtains without paying inventive effort, fall within the scope of protection of the present invention.

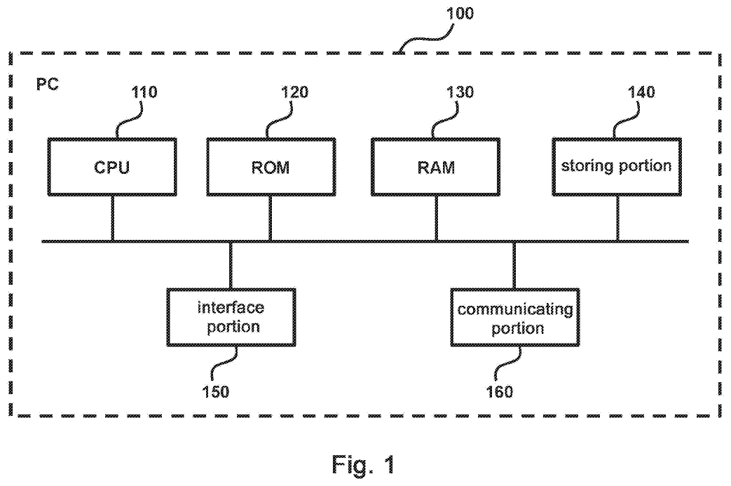

FIG. 1 is a schematic view showing an example of a PC (Personal Computer) 100 as hardware construction realizing a learning data acquiring apparatus 200 according to an illustrative embodiment of the present invention. As shown in FIG. 1, this PC 100 may comprise a CPU 110 configured to perform overall control, a Read Only Memory (ROM) 120 configured to store system software, a Random Access Memory (RAM) 130 configured to store written-in/read-out data, a storing portion 140 configured to store various programs and data, an interface portion 150 as an interface of input and output, and a communicating portion 160 configured to realize a communicating function. Alternatively, the CPU 110 may be replaced by a processor such as a microprocessor MCU or a programmable logic device FPGA. The interface portion 150 may comprise various interfaces such as an input/output interface (I/O interface), a universal serial bus (USB) port (which may be included as one port of ports of the I/O interface), and a network interface. The person ordinarily skilled in the art may understand that the structure shown in FIG. 1 is merely illustrative, and it does not limit the hardware construction of the learning data acquiring apparatus 200. For example, the PC 100 further may comprise more or less components than as shown in FIG. 1, or has a configuration different from that shown in FIG. 1.

It should be noted that the above CPU 100 may comprise one or more processors and/or other data processing circuit, all or part of the one or more processors and/or other data processing circuit may be embodied as software, hardware, firmware or any other combinations. Besides, the one or more processors and/or other data processing circuit may be a single independent processing module, or totally or partially combined in any one of the other parts of the PC 100.

The storing portion 140 may be used to store software programs and modules of application software, for example, a program command/data corresponding to a method for acquiring learning data about a learning object for machine learning to be described later in the present invention, besides, the storing portion 140 also may be used to store commission information, learning data and so on of user commissioned learning. The CPU 110 realizes the above method for acquiring learning data by running the software programs and modules stored in the storing portion 140. The storing portion 140 may comprise a non-volatile memory, e.g. one or more magnetic storage devices, flash memories, or other non-volatile solid state memories. In some examples, the storing portion 140 may further comprise memories remotely provided with respect to the CPU 110, and these remote memories may be connected to the PC 100 via a network. Examples of the above network includes, but not limited to, internet, intranet, local area network, mobile communication network and combinations thereof.

The interface portion 150 may comprise a touch display (also called as “touch screen”). In some examples, the above touch display may present a graphical user interface (GUI), and the user may make man-machine interaction with the GUI by touching the screen with a finger or a touch pen and/or through a gesture, so as to input the commission information for commission learning and etc. Besides, the user also may understand the situation of the learning data collection through an image shown by the above touch display. An executable command for executing the above man-machine interaction function is configured/stored in one or more processor executable computer program products or readable memory media, for example, it may be stored in the storing portion 140.

The communicating portion 160 is used to receive or send data via a network. Examples of the above network may include a wireless network provided by a communication provider of the PC 100. In one example, the communicating portion 160 may comprise a network interface controller (NIC), which may be connected with other network devices through a base station so that it may communicate with the internet. In one example, the communicating portion 160 may be a radio frequency (RF) module, which is configured to communication with the internet in a wireless manner.

The person skilled in the art may understand that the example as the hardware construction realizing the learning data acquiring apparatus 200 according to an illustrative embodiment of the present invention is not limited to the PC 100 shown in FIG. 1, for example, it also may be a terminal device such as intelligent mobile phone (e.g. Android mobile phone, iOS mobile phone), tablet PC, mobile internet device (MID), and PAD. Alternatively, as an example of the hardware construction realizing the learning data acquiring apparatus 200 according to an illustrative embodiment of the present invention, various parts in FIG. 1 other than the interface portion 150 also may be located on a server side or on the cloud.

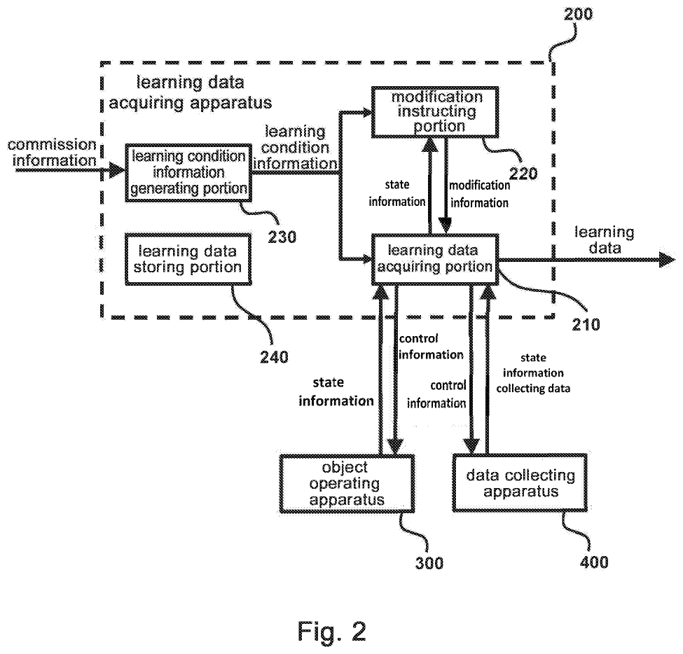

FIG. 2 is a block diagram showing functional modules of the learning data acquiring apparatus 200 according to an illustrative embodiment of the present invention. The learning data acquiring apparatus 200 is used to acquire the learning data about the learning objects for machine learning. An example as the learning objects may for example be desserts on a production line in a food processing plant. By acquiring images about the desserts and good product/defective product information of the desserts as the learning data, a detecting device on the production line may be enabled to utilize the learning data for learning through the existing deep learning method, so as to obtain the capability of judging a dessert as a good product/defective product.

As shown in FIG. 2, the learning data acquiring apparatus 200 according to an illustrative embodiment of the present invention comprises: a learning data acquiring portion 210, which may acquire learning data about learning objects according to learning condition information, the learning condition information being information generated according to the commission information of user commissioned learning; and a modification instructing portion 220, which may modify setting of the learning data acquiring portion for acquiring the learning data according to the learning condition information.

By providing the modification instructing portion 220, the learning data acquiring apparatus 200 may automatically complete a changing operation, without manual participation, according to requirements of acquiring the learning data, for example, when it is needed to change a mechanical arm of an object operating apparatus 300 and to select a suitable camera from a plurality of cameras of a data collecting apparatus 400, so that the configuration accuracy of the object operating apparatus 300 and/or the data collecting apparatus 400 may be improved, the quality of the obtained learning data is improved, and man-made errors which may occur during the part modifying process is avoided. Besides, the learning data acquiring apparatus 200 according to the embodiments of the present invention may save the system resources of the local computer or the server, and improve the learning data acquiring efficiency, by cooperating with the operations of various connected parts.

The “commission information” as referred to in the present invention may include various types of information provided by the user used for commission learning. In one optional embodiment, for example, it may include information of the learning object and information of the learning objective. As one example, for example, when judging a dessert as a good product/defective product on a production line of a food processing plant, the learning objective may be enabling a detecting device on the production line to obtain the capability of judging the dessert as a good product/defective product, or the learning objective may be enabling the detecting device on the production line to obtain the capability of classifying the dessert, the capability of grading and so on. Of course, the commission information still may include various types of other information as long as the object of the present invention may be realized. For example, the commission information may include information related to the user (consignor) and so on.

Further, as shown in FIG. 1, the learning data acquiring apparatus 200 according to an illustrative embodiment of the present invention may further comprise: a learning condition information generating portion 230, receiving from outside the learning condition information or generating the learning condition information according to the commission information, and sending the learning condition information to the learning data acquiring portion 210 and the modification instructing portion 220; and a learning data storing portion 240, storing the learning data.

By providing the learning condition information generating portion 230, the user may intuitively input the commission information, but does not need to have in-depth understanding to the deep learning technology, therefore, the user operation is simplified, and the difficulty of user using the deep learning technology is reduced. For example, the interface portion 150 described above may include the touch display, this touch display may display the GUI which may interact with the user. As an example, the GUI may prompt the user to input information about accuracy of the learning objective, for example, the learning objective is to enable a device to have the capability of distinguishing the good product/defective product or to enable the device to have the capability of grading a product as a first-class product/a second-class product/a third-class product/a defective product. The learning condition information generating portion 230 may determine information about the quantity of the learning data in the learning condition information, information of a data type of a detecting result obtained by detecting a sample and so on.

The person ordinarily skilled in the art may understand that the learning data acquiring apparatus 200 according to an illustrative embodiment of the present invention also may not include the learning condition information generating portion 230, for example, the learning data acquiring portion 210 and the modification instructing portion 220 may receive the learning condition information directly from the outside of the learning data acquiring apparatus 200. Or optionally, the modification instructing portion 220 may not receive the learning condition information directly from the learning condition information generating portion 230, for example, the learning data acquiring portion 210 receives the learning condition information from the learning condition information generating portion 230 or the outside, and provides a part of the information extracted from the learning condition information to the modification instructing portion 220. Likewise, the learning data acquiring apparatus 200 according to an illustrative embodiment of the present invention also may not include the learning data storing portion 240, and the learning data acquiring apparatus 200 provides the acquired learning data to an external storing device or a device to make the deep learning.

The “learning condition information” as referred to in the present invention is information generated according to the commission information of the commission learning provided by the user. In one optional embodiment, for example, the learning data acquiring apparatus 200 may comprise a learning condition information database (not shown in the figures) configured to store the learning condition information, and when receiving the commission information, the learning condition information generating portion 230 retrieves in the learning condition information database for the learning condition information corresponding to the commission information. Alternatively, the learning data acquiring apparatus 200 may store in advance the program configured to generate the learning condition information, and when receiving the commission information, the learning condition information generating portion 230 generates the learning condition information corresponding to the commission information using this program. The learning condition information database or the program for generating the learning condition information may be provided based on the related deep learning technology in advance.

The learning condition information may include various types of information of the learning data about the learning objects. In one optional embodiment, for example, the learning condition information may include information about the learning objects, the learning objective, the object operating apparatus, the data collecting apparatus, the learning data and so on. As an example, the learning condition information may include information about the object operating apparatus 300, for example, the type of the object operating apparatus 300 (e.g. a robot), hardware configuration (e.g. having a plurality of mechanical arms), a controlling method (e.g. controlling procedure, parameter information and so on). The learning data acquiring portion 210 may provide the control information to the object operating apparatus 300 according to the learning condition information, so that the object operating apparatus 300 may perform operation on the learning objects.

The “object operating apparatus” as referred to in the present invention may perform operation on the learning object, so as to make the learning objects take various actions for generating the learning data, or to realize various states of the learning objects and so on. Besides, optionally, the “object operating apparatus” as referred to in the present invention still may perform operation on the data collecting apparatus, so as to make the data collecting apparatus take various actions for collecting data from the learning objects, or to realize various states and so on.

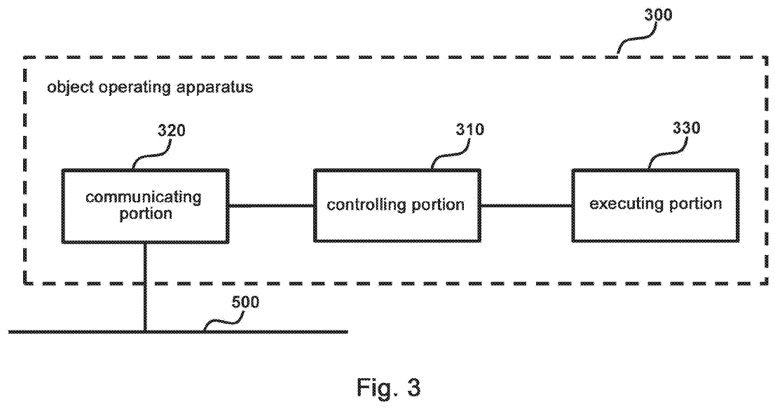

FIG. 3 is a block diagram showing functional modules of the object operating apparatus 300 according to an illustrative embodiment of the present invention. As shown in FIG. 3, the object operating apparatus 300 may comprise a controlling portion 310, a communicating portion 320 and an executing portion 330. The controlling portion 310 controls in general the operations of various parts of the object operating apparatus 300 according to the control information from the learning data acquiring apparatus 200. The executing portion 330 may perform operation on the learning objects and/or the data collecting apparatus. The communicating portion 320 may communicate with the outside through a local area network 500, for example, receive control information from the learning data acquiring apparatus 200, send the state information of the object operating apparatus to the learning data acquiring apparatus 200 and so on. Optionally, the communicating portion 320 also may send/receive the information through various other communicating manners, e.g. internet, intranet, mobile communication network and combinations thereof.

As an example, for example, when judging the dessert as a good product/defective product on the production line of the food processing plant, the object operating apparatus 300 for example may be a robot, and the executing portion 330 for example may be one or more mechanical arms of this robot, while the data collecting apparatus 400 may comprise one or more cameras for capturing the dessert, and a orientation sensor sensing a orientation of a bearing table bearing the dessert. According to the control information received by the communicating portion 320 from the learning data acquiring apparatus 200, the controlling portion 310 controls the executing portion 330 to operate gestures of one or more cameras, and makes a predetermined change occur to the orientation of the bearing table bearing the dessert, so as to take a desired image for the dessert.

In FIG. 2, it is shown that the object operating apparatus 300 provides its state information (e.g. which mechanical arm is used) to the learning data acquiring apparatus 200, but the present invention is not limited to this. The state information of the object operating apparatus 300 also may be provided to the learning data acquiring apparatus 200 through the data collecting apparatus 400.

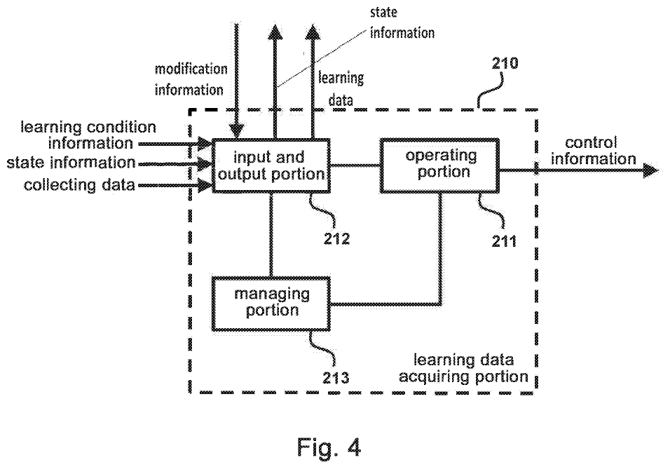

FIG. 4 is a block diagram showing functional modules of the learning data acquiring portion 210 comprised in the learning data acquiring apparatus 200 according to an illustrative embodiment of the present invention. As shown in FIG. 4, the learning data acquiring portion 210 may comprise: an operating portion 211, controlling the object operating apparatus 300 performing operation on the learning objects or the data collecting apparatus 400 collecting data from the learning objects; an input and output portion 212, receiving the data collected by the data collecting apparatus 400, and outputting the learning data generated according to the data; and a managing portion 213, managing various parts of the learning data acquiring portion 210 such as the operating portion 211, the input and output portion 212.

As an example, for example, the input and output portion 212 receives the learning condition information from the learning condition information generating portion 230 and provides the same to the managing portion 213. The managing portion 213, according to a program or database stored in advance, may analyze the learning condition information, generate a corresponding operation command, and provide the same to the operating portion 211. The operating portion 211 provides control information to the object operating apparatus 300 and/or the data collecting apparatus 400 according to this operation command, so as to control the operations of the object operating apparatus 300 and/or the data collecting apparatus 400.

Further, the learning condition information may include operation information about the object operating apparatus 300 or the data collecting apparatus 400, and according to the operation information, the modification instructing portion 220 may modify setting for operating the object operating apparatus 300 and/or the data collecting apparatus 400 by the operating portion 211. As an example, the operation information indicates the data collecting apparatus 400 comprising a plurality of cameras, and the modification instructing portion 220 may provide modification information to the managing portion 213 according to the operation information, to modify setting for operating the data collecting apparatus 400 by the operating portion 211, so that the operating portion 211 providing the control information to a first camera may be modified to the operating portion 211 providing control information to a second camera.

Thus, the learning data acquiring apparatus 200 may modify the operations of the object operating apparatus 300 and/or the data collecting apparatus 400, when necessary, according to customer commissioned requirements, so as to simplify the user operation, improve the learning data acquiring efficiency, and save the system resources of the local computer or the server.

As another example, for example, the input and output portion 212 may receive the learning condition information from the learning condition information generating portion 230 and the state information from the object operating apparatus 300 and/or the data collecting apparatus 400, and provide the same to the managing portion 213. The managing portion 213, according to a program or database stored in advance, may analyze the learning condition information, generate a corresponding operation command, and provide the same to the operating portion 211. The operating portion 211 provides control information to the object operating apparatus 300 and/or the data collecting apparatus 400 according to this operation command, so as to control the operations of the object operating apparatus 300 and/or the data collecting apparatus 400.

Further, the input and output portion 212 may provide the state information of the object operating apparatus 300 and/or the data collecting apparatus 400 to the modification instructing portion 220. The modification instructing portion 220 may modify the setting for operating the object operating apparatus 300 and/or the data collecting apparatus 400 according to the operation information and the state information by the operating portion 211. As an example, for example, the operation information indicates the data collecting apparatus 400 comprising a plurality of cameras, and the state information indicates one of the cameras being in a fault state. The modification instructing portion 220 may provide modification information to the managing portion 213 according to the operation information and the state information, to modify the setting for operating the data collecting apparatus 400 by the operating portion 211, so that the operating portion 211 providing the control information to the camera in a fault state may be modified to the operating portion 211 providing control information to other cameras without a fault.

Thus, the learning data acquiring apparatus 200 may modify the operations of the object operating apparatus 300 and/or the data collecting apparatus 400, when necessary, not only according to the customer commissioned requirements, but also according to the specific situations of the used object operating apparatus 300 and/or the data collecting apparatus 400, so as to simplify the user operation, improve the learning data acquiring efficiency, and save the system resources of the local computer or the server.

The above is merely for describing the functional modules of the learning data acquiring apparatus 200 according to an illustrative embodiment of the present invention. The person ordinarily skilled in the art may understand that the division of the above functional modules is merely a logical function division, while there may be a plurality of different dividing manners in practical implementation, for example, part or all of the modification instructing portion 220 may be combined or integrated into the learning data acquiring portion 210. The above functional modules may be physically integrated or separated, they may be located in one place, and also may be distributed onto a plurality of network units, and a suitable implementing manner may be chosen according to practical requirements.

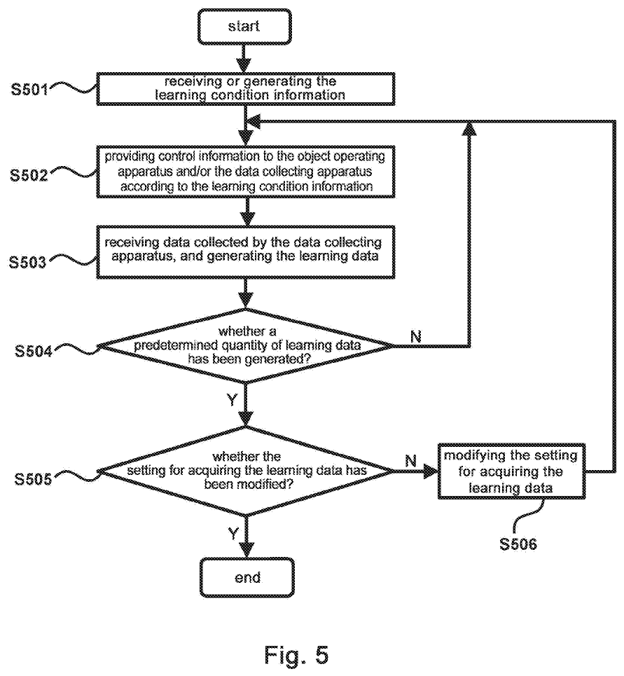

Below a learning data acquiring method according to an illustrative embodiment of the present invention is described in conjunction with FIG. 5. FIG. 5 is a flow chart showing a learning data acquiring method according to an illustrative embodiment of the present invention. As shown in FIG. 5, in Step S501, a learning condition information generating portion 230 receives from outside the learning condition information or generates the learning condition information according to the commission information input by the user, and provides the learning condition information to the learning data acquiring portion 210 and the modification instructing portion 220, and then the method proceeds to Step S502.

In Step S502, the learning data acquiring portion 210 provides control information to the object operating apparatus 300 and/or the data collecting apparatus 400 according to the learning condition information, so that the object operating apparatus 300 and/or the data collecting apparatus 400 takes a corresponding action, and then the method proceeds to Step S503. In Step S503, the learning data acquiring portion 210 receives data collected by the data collecting apparatus 400, and generates the learning data in combination with other data (e.g. the state information of the learning objects, such as good product/defective product), and then the method proceeds to Step S504.

In Step S504, the learning data acquiring portion 210 determines whether a predetermined quantity of learning data has been generated. If the predetermined quantity of learning data has not been generated (a judging result is “NO”), it returns back to Step S502 of the method, to continue to generate next learning data; if the predetermined quantity of learning data has been generated (the judging result is “YES”), the method proceeds to Step S505.

In Step S505, the modification instructing portion 220 determines whether the setting of the learning data acquiring portion 210 for acquiring the learning data has been modified. If modification is needed but has not been made (a judging result is “NO”), the method proceeds to Step S506. In Step S506, the modification instructing portion 220 modifies the setting of the learning data acquiring portion 210 for acquiring the learning data according to the learning condition information, then it returns back to Step S502 of the method, to continue to generate the learning data in the modified circumstance; if the modification has been made (the judging result is “YES”), it means that the acquiring of the learning data has been made in each modified circumstance at this time, and the flow is ended.

In the learning data acquiring method according to an illustrative embodiment of the present invention as shown in FIG. 5, in Step S504, the learning data acquiring portion 210 determines whether the predetermined quantity of learning data has been generated. The predetermined quantity of information may be part of the learning condition information. For example, in the case of acquiring the learning data for training a machine to obtain grading capability, the quantity of the learning data required may be determined according to the grading accuracy information in the commission information input by the user, and the quantity information may act as part of the learning condition information for controlling the generation of the learning data.

Optionally, in Step S504, instead of judging the quantity, time also may be judged. For example, in Step S504, the learning data acquiring portion 210 may judge whether the generation of the learning data of predetermined time has been performed. If the generation has not been performed for the predetermined time (a judging result is “NO”), it returns back to Step S502 of the method, to continue to generate next learning data; if the generation has been performed for the predetermined time (the judging result is “YES”), the method proceeds to Step S505.

Based on the above learning data acquiring method, the user only needs to input the commission information, and may obtain the desired learning data without being involved in the process of generating the learning data too much. This greatly simplifies the user's operation, so that the user also may utilize the deep learning technology without the need of understanding knowledge such as the deep learning algorithm.

### First Application Example

When grabbing an article using a grabbing device on a production line, there exists the possibility of failed grabbing. In the first application example, the articles in a container C1 may be irregularly arranged, for example, they may be stacked, and the shapes of the articles themselves also may be irregular. Therefore, the part of the article grabbed by a mechanical arm and the type of the mechanical arm used for performing the grabbing operation both will affect the success rate of grabbing the article. In the first application example, it is desired to obtain the learning data for deep learning for improving the grabbing success rate. The grabbing device on the production line may use the learning data for learning so as to improve the grabbing success.

During the process of acquiring the learning data, according to factors such as different commission information input by a user, learning contents correspondingly will be different, and the mechanical arm of a robot should be changed according to the learning content. For example, switching is made between a high-accuracy mechanical arm and a low-accuracy mechanical arm. In general, the high-accuracy mechanical arm may realize more accurate grabbing operation, while its operation time will be shorter than the low-accuracy mechanical arm. For another example, switching is made between a finger mechanical arm and a suck tray mechanical arm. In general, the finger mechanical arm is more advantageous when grabbing irregular articles or fragile articles, while its operation efficiency will be lower than the suck tray mechanical arm.

As an example of the commission information input by the user, for example, information about user preference may be included therein. When the user desires preference of time, the low-accuracy mechanical arm may be used to grab the articles; when the user desires preference of the grabbing success rate, the high-accuracy mechanical arm may be used to grab the articles. As another example of the commission information input by the user, for example, information of article type may be included therein. When the articles are irregular articles or fragile articles, the finger mechanical arm may be used to grab the articles; when the articles are regular articles, the suck tray mechanical arm may be used to grab the articles.

The commission information input by the user for example further may include various other types of information. For example, information about accuracy of the learning data may be included therein. When the user desires to obtain low-accuracy learning data, it may only judge whether a grabbing result is success or failure; when the user desires to obtain high-accuracy learning data, for example, the grabbing result may be one selected from undamaged picking and placing, damaged picking and placing, and failed picking and placing.

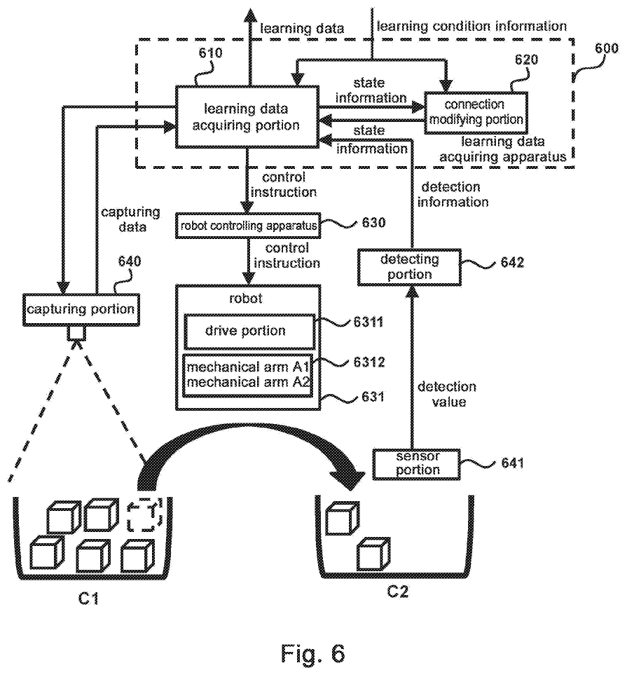

FIG. 6 is a block diagram showing functional modules of the first application example of the learning data acquiring apparatus 200 according to an illustrative embodiment of the present invention. In FIG. 6, a learning data acquiring apparatus 600 is equivalent to the learning data acquiring apparatus 200, a learning data acquiring portion 610 is equivalent to the learning data acquiring portion 210, a connection modifying portion 620 is equivalent to the modification instructing portion 220, a robot controlling apparatus 630 and a robot 631 are equivalent to the object operating apparatus 300, a capturing portion 640, a sensor portion 641 and a detecting portion 642 are equivalent to the data collecting apparatus 400.

The learning data acquiring portion 610 provides control information to the robot controlling apparatus 630 according to learning condition information, so that the robot controlling apparatus 630 sends a control command to the robot 631 on the basis the control information to control actions of the robot 631. The robot 631 may comprise a drive portion 6311 and a mechanical arm portion 6312, and the drive portion 6311 receives the control command from the robot controlling apparatus 630 to drive the mechanical arm portion 6312 to perform a grabbing operation. The mechanical arm portion 6312 for example may comprise a plurality of mechanical arms, for instance, FIG. 6 shows two mechanical arms, a mechanical arm A1 and a mechanical arm A2. The drive portion 6311 may switch among a plurality of mechanical arms according to the control command. The mechanical arm portion 6312 grabs the articles placed in the container C1, and places the same into a container C2.

The learning data acquiring portion 610 sends a capturing instruction to the capturing portion 640 according to the learning condition information, and the capturing portion 640 captures the articles in the container C1 to acquire image data of the articles. During the process of acquiring one learning data, a capturing operation of the capturing portion 640 and a grabbing operation of the robot 631 are synergetic. For example, the learning data acquiring portion 610 may firstly control the capturing portion 640 to take one picture of the articles in the container C1, determine one article to be grabbed according to this picture and calculate optimal coordinates of the robot. Then, the learning data acquiring portion 610 may control the robot to move towards the optimal coordinates, and perform the grabbing operation using the mechanical arms of the robot, thereafter, images around the optimal coordinates are taken using the capturing portion 640, so as to obtain the image data. The image data may be provided to the learning data acquiring portion 610 as a part of the learning data.

The capturing portion 640 may comprise a plurality of cameras, and the plurality of cameras simultaneously capture the article to be grabbed from different orientations, so as to obtain a plurality of pictures of the article to be grabbed at different orientations. Alternatively, the capturing portion 640 may merely comprise one camera, and this camera captures the article to be grabbed from different orientations in sequence, so as to obtain a plurality of pictures of the article to be grabbed at different orientations. A plurality of pictures may be synthesized in the capturing portion 640 into a panoramic picture about the article to be grabbed and provided to the learning data acquiring portion 610 as a part of the learning data; alternatively, the pictures are directly provided to the learning data acquiring portion 610 by the capturing portion 640, and processed by the learning data acquiring portion 610 into a part of the learning data.

The sensor portion 641 detects the grabbing action performed by the mechanical arm portion 6312, and provides a detection value to the detecting portion 642. The detecting portion 642 generates detection information according to this detection value and provides the same to the learning data acquiring portion 610. The learning data acquiring portion 610 takes the detection information as a part of the learning data. The sensor portion 642 for example may comprise various types of known sensor parts such as an IR sensor, a weight sensor, and an image sensor. As an alternative, the result of the grabbing action performed by the mechanical arm portion 6312 also may be manually judged and input.

The connection modifying portion 620 modifies setting of the learning data acquiring portion 610 for acquiring the learning data according to the learning condition information. For example, the learning condition information may include information of the above article type. As shown in FIG. 6, the connection modifying portion 620 receives the learning condition information, generates modification information of modifying the mechanical arm used in the mechanical arm portion 6312 according to the learning condition information, and provides the modification information to the learning data acquiring portion 610. Accordingly, the learning data acquiring portion 610 provides to the robot controlling apparatus 630 control information including a command of modifying the mechanical arm, so that using the mechanical arm A1 for performing the grabbing operation is modified to using the mechanical arm A2 for performing the grabbing operation.

Thus, when a plurality of mechanical arms need to be used for performing an operation on the learning objects, the mechanical arms do not need to be manually changed, while the change of the mechanical arms may be automatically completed in a way of the connection modifying portion 620 providing the modification information, therefore, the manpower is saved, and man-made errors are avoided. Moreover, the learning data acquiring apparatus 600, the object operating apparatus 300, and the data collecting apparatus 400 may operate synergetically, improving the efficiency of acquiring the learning data, and saving the system resources.

Although it is not shown in FIG. 6, the learning data acquiring portion 610 may receive state information about the robot 631, the capturing portion 640 and/or the sensor portion 641, for example, identification information of the currently used mechanical arm of the robot 631, information of orientation and capturing parameters of the camera used by the capturing portion 640, accuracy information of the sensor in the sensor portion 641 and so on. The learning data acquiring portion 610 may provide the information to the connection modifying portion 620, so as to act as one of the conditions for generating the modification information. Optionally, the connection modifying portion 620 also may directly receive the state information about the robot 631, the capturing portion 640 and/or the sensor portion 641, without transmission via the learning data acquiring portion 610.

FIG. 6 shows an example of modifying the mechanical arm of the robot through the connection modifying portion 620, however, optionally, the setting of the learning data acquiring portion 610 for operating the capturing portion 640 and/or the sensor portion 641 also may be modified through the connection modifying portion 620. For example, in a situation that the capturing portion 640 comprises a plurality of cameras, the connection modifying portion 620 may instruct that capturing is performed by one, multiple or all of the plurality of cameras. For example, in a situation that one camera among the plurality of cameras is failed, the connection modifying portion 620 may instruct to switch from the manner of capturing with a plurality of cameras and then synthesizing panoramic image data to a manner of capturing with one camera from a plurality of orientations and then synthesizing panoramic image data. Similarly, in a situation that the sensor portion 641 comprises a plurality of sensors, the connection modifying portion 620 may instruct to perform the detection through one, multiple or all of the plurality of sensors.

Thus, similarly, when a plurality of cameras and/or a plurality of sensors need to be used for performing the data collection for the learning objects, the cameras and/or the sensors do not need to be manually configured or changed, while the configuration and change may be automatically completed in a way of the connection modifying portion 620 providing the modification information, therefore, the manpower is saved, and the man-made errors are avoided. Moreover, the learning data acquiring apparatus 600, the object operating apparatus 300, and the data collecting apparatus 400 may operate synergetically, improving the efficiency of acquiring the learning data, and saving the system resources.

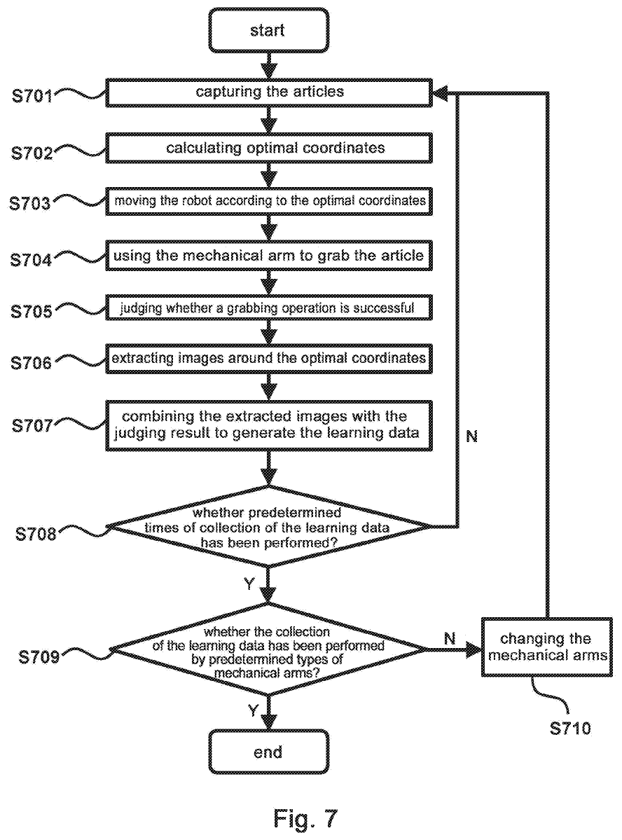

FIG. 7 is a flow chart of one example of the learning data acquiring method of the first application example. In this example, the collection of the learning data is performed through a plurality of types of mechanical arms. As shown in FIG. 7, in Step S701, the learning data acquiring portion 610 instructs the capturing portion 640 to take an image of the articles in the container C1, and determines the article to be grabbed among the articles according to this image, and then the method proceeds to Step S702. In Step S702, the learning data acquiring portion 610 calculates optimal coordinates of the mechanical arm A1 for grabbing the article to be grabbed according to a position and a orientation of the article to be grabbed in the image, and provides to the robot controlling apparatus 630 the optimal coordinates as a part of the control information, and then the method proceeds to Step S703. In Step S703, the robot controlling apparatus 630 moves the robot 631 according to the optimal coordinates, and then the method proceeds to Step S704. In Step S704, the robot 631 uses the mechanical arm A1 to grab the article to be grabbed, and then the method proceeds to Step S705.

In Step S705, the sensor portion 641 detects articles in the container C2, and sends a detection value to the detecting portion 642. The detecting portion 642 determines whether a grabbing operation of the mechanical arm A1 is successful according to this detection value, and provides detection information indicating success or not to the learning data acquiring portion 610, and then the method proceeds to Step S706. In Step S706, the learning data acquiring portion 610 again instructs the capturing portion 640 to perform capturing, and extracts images around the optimal coordinates as capturing data, and then the method proceeds to Step S707. In Step S707, the learning data acquiring portion 610 combines the capturing data (extracted images) with the detection information (judging result) to generate the learning data, and stores or outputs the learning data outwards. Then the method proceeds to Step S708.

In Step S708, the learning data acquiring portion 610 determines whether predetermined times of collection of the learning data has been performed. If the predetermined times of collection of the learning data has not been performed (S708: NO), it returns back to Step S701 of the method, and next collection of the learning data is performed; if the predetermined times of collection of the learning data has been performed (S708: YES), the method proceeds to Step S709.

In Step S709, the connection modifying portion 620 determines whether the collection of the learning data has been performed by predetermined types of mechanical arms, for example, whether the collection of the learning data has been performed respectively by the mechanical arm A1 and the mechanical arm A2 of a different type of the mechanical arm A1. If a judging result is “NO” (S709: NO), Step S710 of the method is performed; if the judging result is “YES” (S709: YES), the flow is ended.

In Step S710, the connection modifying portion 620 provides modification information to the learning data acquiring portion 610, so that the learning data acquiring portion 610 provides control information to the robot controlling apparatus 630, so as to modifying the operation of using the mechanical arm A1 to grab the article to the operation of using the mechanical arm A2 to grab the article, and thereafter it returns back to Step S701 of the method, and collection of next group of learning data is performed.

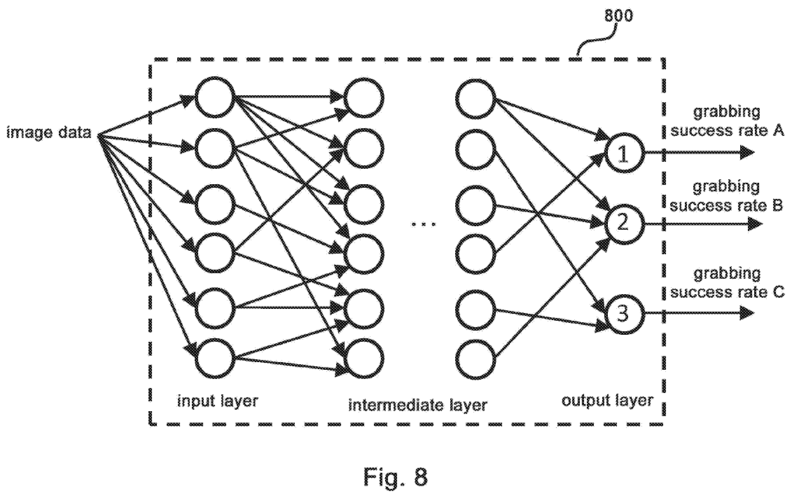

Thus, the learning data acquiring portion 610 may acquire a plurality of sets of learning data corresponding to a plurality of mechanical arms respectively. FIG. 8 is a schematic view showing one example of performing deep learning using the learning data acquired with the above learning data acquiring method. In this example, each learning data comprises capturing data (extracted images) and detection information (judging results). As shown in FIG. 8, a deep learning network 800 comprises an input layer, a intermediate layer and an output layer. The learning data is input as input data into the input layer of this deep learning network 800. An article image as a part of the input data may be image data obtained by capturing with a single camera, and also may be image data synthesized after capturing with a plurality of cameras, for example, panoramic image data of the article. There may be multiple intermediate layers, analyzing the image data using the deep learning technology. The output layer may be corresponding to a grabbing success rate. For example, when an output of the output layer on No. 1 is 1, it indicates that the grabbing success rate is A. This deep learning network 800 may be comprised in a detecting device (not shown in the figures) on a production line.

Through the learning as shown in FIG. 8, the grabbing device on the production line may know the grabbing success rate and used time of respective mechanical arms in different situations (e.g. different articles), so that the use of the mechanical arms is optimized. For example, the detecting device may choose a suitable mechanical arm by automatically judging the article to be grabbed and according to the user preference, so as to obtain an optimal combination of the grabbing success rate and the processing time.

Similarly, through the learning as shown in FIG. 8, the grabbing device also may choose a suitable camera from a plurality of cameras for capturing the articles, and choose a suitable sensor from a plurality of sensors for detecting the article by automatically judging the article to be grabbed and according to the user preference, so as to optimize the data collection.

### Second Application Example

In a power plant using a solar panel for power generation, it is very important to ensure normal operation of the solar panel. In the second application example, a drone having a GPS is used to monitor a surface of the solar panel, so as to be able to judge an abnormality of the solar panel in advance, and measures such as change or maintenance may be adopted before it is damaged. Therefore, it is desired to obtain image data of the surface of the solar panel as a part of learning data, so that a monitoring device of the power plant performs deep learning utilizing the learning data, characteristic quantity of the solar panel may be extracted, and the abnormality of the solar panel may be judged in advance by using the drone periodically for capturing the solar panel.

When the surface of the solar panel is monitored using the drone having a GPS, an initialization operation should be performed on the drone, for example, a power condition of a battery of the drone should be detected, and the drone having insufficient power is charged; the storage space of the drone should be detected to judge whether it may meet capturing requirement, and when the storage space is insufficient, operation of deleting data is performed; a capturing path should be set, and path information is stored in a storing portion of the drone, and so on. When a plurality of drones are used for monitoring, there will be a problem of how to orderly and automatically complete operations of all drones. In the second application example, this problem is solved by provided a connection modifying portion 920.

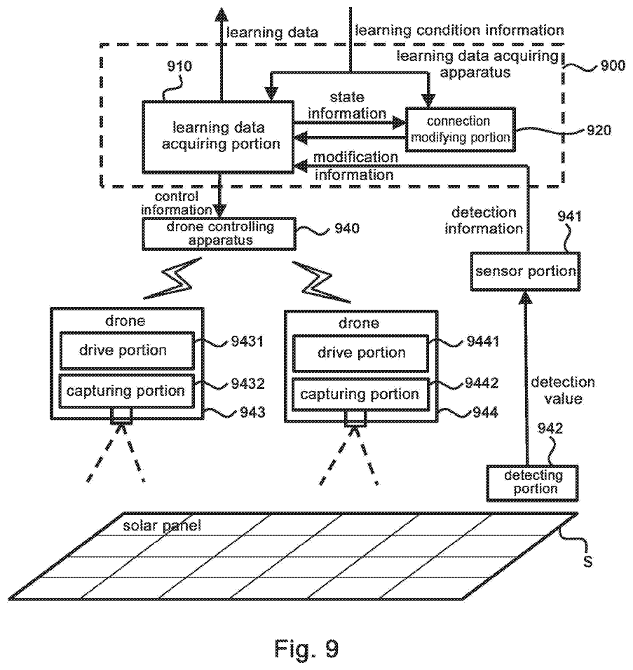

FIG. 9 is a block diagram showing functional modules of the second application example of the learning data acquiring apparatus 200 according to an illustrative embodiment of the present invention. In FIG. 9, a learning data acquiring apparatus 900 is equivalent to the learning data acquiring apparatus 200, a learning data acquiring portion 910 is equivalent to the learning data acquiring portion 210, a connection modifying portion 920 is equivalent to the modification instructing portion 220, and a drone controlling apparatus 940, a sensor portion 941 and a detecting portion 942, a drone 943 and a drone 944 are equivalent to the data collecting apparatus 400. FIG. 9 shows the drone 943 and the drone 944, but the present invention is not limited to this, and the number of the drone may be determined as practically demanded.

The learning data acquiring portion 910 provides control information to the drone controlling apparatus 940 according to learning condition information, so that the drone controlling apparatus 940 sends a control command to the drone 943 and the drone 944 on the basis the control information to control actions of the drone 943 and the drone 944. The drone 943 comprises a drive portion 9431 and a capturing portion 9432, besides, it further may comprise a power portion, a flying vehicle portion, a storing portion and so on which are not shown. The drive portion 6431 receives a control command from the drone controlling apparatus 940, to control operations of the capturing portion 9432 and the power portion, the flying vehicle portion, the storing portion and so on which are not shown. The capturing portion 9432 may capture a solar panel S so as to acquire image data of a surface of the solar panel S. The capturing portion 9432 for example may comprise a visible light camera and an IR camera, so that visible light image data and IR image data may be simultaneously acquired. The power portion may have a storage battery so as to provide power to the drone 943. The flying vehicle portion may execute a flight operation under an instruction of the drive portion 9431. The storing portion may store control program information, flight line information, image data shot by the capturing portion 9432 and so on. Similarly, the drone 944 may have the same or similar construction as the drone 943, for example, may comprise a drive portion 9441 and a capturing portion 9442.

The sensor portion 942 detects the operation situation of the solar panel S, for example, the sensor portion 942 may comprise a detecting resistor detecting an output voltage or an output current of the solar panel S. The sensor portion 942 provides a detection value obtained by the detection to the detecting portion 941, the detecting portion 941 generates detection information according to this detection value and provides the same to the learning data acquiring portion 910, and the learning data acquiring portion 910 takes the detection information as a part of the learning data.

The connection modifying portion 920 modifies setting of the learning data acquiring portion 910 for acquiring the learning data according to the learning condition information. For example, the learning condition information may include information of the number of the solar panel S to be monitored. The connection modifying portion 920 may modify the setting of the learning data acquiring portion 910 about the number of the drone used for acquiring the learning data according to this information of the number. As another example, for example, the learning condition information may include user preference information about detection accuracy/time. The connection modifying portion 920 may modify setting of the learning data acquiring portion 910 about image data used for acquiring the learning data according to the user preference information, for example, only visible light image data is used, or the visible light image data and the IR image data are simultaneously used.

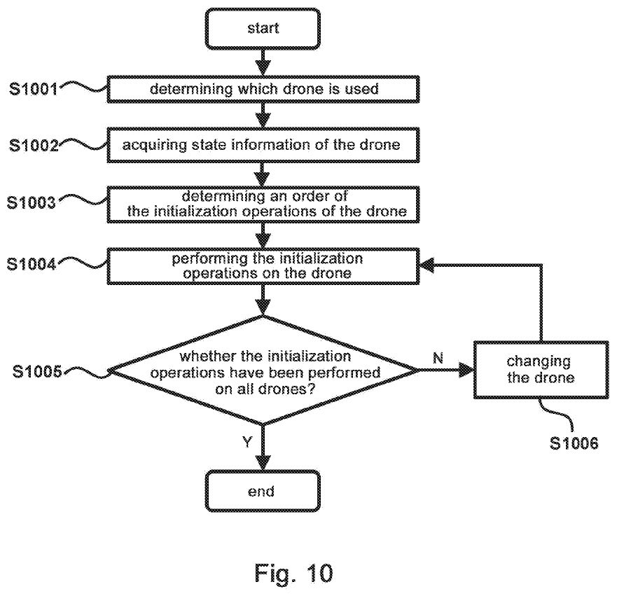

When a plurality of drones are used for monitoring, the connection modifying portion 920 may orderly and automatically complete the initialization operations of all drones by modifying setting of the learning data acquiring portion 910 for initializing the drones. Description is made therefor in conjunction with FIG. 10.

FIG. 10 is a flow chart of one example of the learning data acquiring method of a second application example. As shown in FIG. 10, in Step S1001, the connection modifying portion 920 determines which drone is used for capturing the solar panel S according to the learning condition information. For example, the connection modifying portion 920 determines to use 2 drones for capturing according to the information about the number of the solar panel S which needs to be monitored included in the learning condition information; for another example, the connection modifying portion 920 determines to use a drone having suitable capturing accuracy according to the information about the accuracy of the learning data included in the learning condition information. In the present example, the connection modifying portion 920 determines to use the drone 943 and the drone 944 for capturing, and then the method proceeds to Step S1002. In Step S1002, the learning data acquiring portion 910 acquires current state information of the drone 943 and the drone 944, and provides the state information to the connection modifying portion 920. The state information for example includes power information, storage space information, collection parameter information and so on, and then the method proceeds to Step S1003.

In Step S1003, the connection modifying portion 920 determines an order of the initialization operations of the drone 943 and the drone 944 according to the state information. For example, in a situation that the state information of the drone 943 and the drone 944 is as shown in the following table, the connection modifying portion 920 determines to firstly perform the initialization operation for the drone 943, and then to perform the initialization operation on the drone 944, so as to reduce the time of the total initialization operations, because the time for preparing an available storage space is usually shorter than the time for charging the drone. In a situation that the initialization of the drone 943 is firstly completed, the drone 943 may be instructed to take off immediately to capture the solar panel S, without the need of waiting for both drones to complete the initialization operations.

| | | | Available | Capturing | |
|---|---|---|---|---|---|
| | Identifier | Power | Storage Space | Accuracy | . . . |
| Drone 943 | xxx | 90% | 30% | High | . . . |
| Drone 944 | yyy | 10% | 90% | High | . . . |

Thereafter, the method proceeds to Step S1004. In Step S1004, the learning data acquiring portion 910 instructs the drone controlling apparatus 940 to perform the initialization operations on the drone 943. The initialization operation for example includes charging, preparing the storage space or setting the collection parameters and so on. After the initialization operation of the drone 943 is completed, the method proceeds to Step S1005. In Step S1005, the connection modifying portion 920 determines whether the initialization operations have been performed on all drones chosen to be used. In a situation that the initialization operations have not be performed on all of the drones chosen to be used (S1005: NO), the method proceeds to Step S1006, and the connection modifying portion 920 provides modification information to the learning data acquiring portion 910, so as to perform the initialization operation on the next drone. In a situation that the initialization operations have been performed on all drones chosen to be used (S1005: YES), the flow is ended.

In the second application example, the connection modifying portion 620 may perform the initialization operations of the drone in an optimal order according to the user requirements and the specific condition of the used drone, without manual participation, therefore, the automation level of acquiring the learning data is improved, and the time required by the initialization operation is saved.

### Third Application Example

In the above second application example, the connection modifying portion 920 modifies the setting of the learning data acquiring portion 910 for the initialization of the drone according to the learning condition information, while the present invention is not limited to this. For example, the connection modifying portion 920 may modify the setting of the learning data acquiring portion 910 about a communicating manner between the drone and the drone controlling apparatus according to the learning condition information.

Specifically, the drone 943 and the drone 944 may communication with the drone controlling apparatus 940 in any one of a wireless communication manner (for example, Bluetooth, NFC, Wifi and so on) and wired communication manner (for example, cable communication, optical cable communication). Moreover, the drone 943 and the drone 944 may communicate with the drone controlling apparatus 940 during the initialization process or after returning to a designated place after the capturing is completed, and also may communicate with the drone controlling apparatus 940 in real time during the process of capturing the solar panel S. The connection modifying portion 920 may provide modification information to the learning data acquiring portion 910 to modify the setting the learning data acquiring portion 910 about the communicating manner of the drone. For example, the learning condition information may include location information of the solar panel S. When the distance of the solar panel S to the drone controlling apparatus 940 is beyond the wireless communication range, the connection modification portion 920 may generate modification information indicating to use the wired communication manner for communication, and provides the modification information to the learning data acquiring portion 910. The learning data acquiring portion 910 may send control information to the drone controlling apparatus 940 in advance, to instruct the drone controlling apparatus 940 to feed bac shot image data in a wired manner after the drone completes the capturing and returns back to a designated place.

As another example, the connection modification portion 920 also may modify setting of a managing portion (not shown in the figures) of the learning data acquiring portion 910 about the learning condition information according to the learning condition information.

For example, for the commission information input by the user, first learning condition information for acquiring image data of the solar panel S in direct solar radiation and second learning condition information for acquiring image data of the solar panel S in the late afternoon or in the night may be generated. The learning data acquiring portion 910, using the first learning condition information and the second learning condition information, may enable the drone to use different control programs, different flight lines or different image accuracies for capturing. The connection modification portion 920 may modify the setting of the managing portion according to switching condition (for example, time and so on) in the learning condition information, so that controlling the drone to acquire the learning data according to the first learning condition information is switched to controlling the drone to acquire the learning data according to the second learning condition information.

As another example, the connection modification portion 920 also may modify the setting of the managing portion (not shown in the figures) of the learning data acquiring portion 910 about a control program according to the learning condition information.

The drone controlling apparatus 940 may set a flight line of the drone for capturing the solar panel S by designating a plurality of places on a map according to the location of the drone having a GPS and map information of the place where the solar panel is located, and also may set a flight line making the drone return back to a position designated by the drone controlling apparatus after flying according to the designated flight line. On the basis of information such as user preference (for example, time preference), there may exist a plurality of control programs generating the flight line. In this situation, the connection modification portion 920 may modify setting the managing portion (not shown in the figures) of the learning data acquiring portion 910 about a control program used by the drone controlling apparatus 940 for generating the drone flight line according to the learning condition information (for example, including user preference information), so that switching may be made between a plurality of control programs.

As a specific switching manner, for example, the drone controlling apparatus 940 may judge whether there is a drone within a range it may utilize wireless LAN communication, and send to the drone a new flight line generated by the control program after the modification, so as to update the flight line of the drone. After the updating, the drone flies again according to the modified flight line so as to be capable of collecting image data along the modified flight line.

In the above application example, the drone controlling apparatus 940 may be comprised in the learning data acquiring apparatus. In order to improve the efficiency of collecting the learning data, a plurality of drones may be enabled to fly simultaneously for capturing. The drone controlling apparatus 940 may set a landing position of respective drones after completing the fling as places where the drone controlling apparatus 940 itself, a charging apparatus, a communicating apparatus and son are located. For example, the drone controlling apparatus 940 may comprise a robot, and the robot is used to connect the drone to the charging apparatus after landing. The drone controlling apparatus 940 may control the drone to fly again after the charging is finished. Besides, the robot also may connect a drone USB or LAN with a communicating apparatus so as to collect image data shot during the flight.

In the above application example, the connection modifying portion 920 may arrange the initialization operation, capturing operation, data feeding back operation and so on of a plurality of drones according to the commission information provided by the user, so that the automation level of monitoring the solar panel S may be improved, and the learning data acquiring efficiency may be improved.

When the above learning data acquiring apparatus 200, 600, 900 or a part thereof, if realized in a form of software functional unit and sold or used as an independent product, may be stored in one computer readable storing medium. Based on such understanding, the technical solution of the present invention essentially or the part making contribution to the prior art or part of this technical solution may be embodied in a form of software product, and this computer software product is stored in one storing medium, including several commands used to make one computer device (which may be a personal computer, a sever, or a network device etc.) execute all or part of the steps of the methods of various examples of the present invention. The aforementioned storing medium includes various media that may store program codes, such as U disk, mobile hard disk, Read-Only Memory (ROM), Random Access Memory (RAM), diskette or compact disk and so on, and also may include data flow which may be downloaded from a server or a cloud.

The above is merely preferred embodiments of the present invention. It should be indicated that for the person ordinarily skilled in the art, several improvements and modifications still may be made without departing from the principle of the present invention, and these improvements and modifications also should be considered as the protection scope of the present invention.

LIST OF REFERENCE SIGNS

| | | | |
|---|---|---|---|
| 100 | PC | 110 | CPU |
| 120 | ROM | 130 | RAM |
| 140 | storing portion | 150 | interface portion |
| 160 | communicating portion | | |
| 200, 600, 900 | learning data acquiring apparatus | | |
| 210, 610, 910 | learning data acquiring portion | | |
| 220 | modification instructing portion | | |
| 620, 920 | connection modifying portion | | |
| 230 | learning condition information | | |
| | generating portion | | |
| 240 | learning data storing portion | | |
| 300 | object operating apparatus | 310 | controlling portion |
| 320 | communicating portion | 330 | executing portion |
| 400 | data collecting apparatus | 500 | local area network |
| 211 | operating portion | 212 | input and output portion |
| 213 | managing portion | | |
| 630 | robot controlling apparatus | 631 | robot |
| 640 | capturing portion | 641, 941 | sensor portion |
| 642, 942 | detecting portion | 6311 | drive portion |
| 6312 | mechanical arm portion | A1, A2 | mechanical arm |
| C1, C2 | container | 800 | deep learning network |
| 940 | drone controlling apparatus | 943, 944 | drone |
| 9431, 9441 | drive portion | 9432, 9442 | capturing portion |
| S | solar panel. | | |

1. A learning data acquiring apparatus, configured to acquire learning data about learning objects for machine learning, comprising a processor configured with a program to perform operations comprising:
operation as a learning data acquiring portion configured to acquire the learning data about the learning objects according to learning condition information, the learning condition information being information generated according to commission information of user commissioned learning; and
operation as a modification instructing portion configured to modify setting of operation as the learning data acquiring portion for acquiring the learning data according to the learning condition information.

2. The learning data acquiring apparatus according to claim 1, wherein the processor is configured with the program to perform operations such that operation as the learning data acquiring portion comprises:
operation as an operating portion configured to control an object operating apparatus performing an operation on the learning objects or a data collecting apparatus collecting data from the learning objects; and
operation as an input and output portion configured to receive the data collected by the data collecting apparatus, and output the learning data generated according to the data.

3. The learning data acquiring apparatus according to claim 2, wherein
the learning condition information comprises operation information about the object operating apparatus or the data collecting apparatus, and
the processor is configured with the program to perform operations such that, according to the operation information, operation as the modification instructing portion is further configured to modify the setting for operating the object operating apparatus or the data collecting apparatus by operation as the operating portion.

4. The learning data acquiring apparatus according to claim 2, wherein
the learning condition information comprises operation information about the object operating apparatus or the data collecting apparatus, and
the processor is configured with the program to perform operations such that:
operation as the input and output portion is further configured to receive state information about the object operating apparatus or the data collecting apparatus, and
according to the operation information and the state information, operation as the modification instructing portion is further configured to modify the setting for operating the object operating apparatus or the data collecting apparatus by operation as the operating portion.

5. The learning data acquiring apparatus according to claim 3, wherein the object operating apparatus comprises a first operating portion and a second operating portion, and both the first operating portion and the second operating portion are capable of operating the learning objects, wherein
the processor is configured with the program to perform operations such that operation as the modification instructing portion is further configured to modify the setting for operating the object operating apparatus by operation as the operating portion, so that using the first operating portion to operate the learning objects is switched to using the second operating portion to operate the learning objects.

6. The learning data acquiring apparatus according to claim 3, wherein the data collecting apparatus comprises a first collecting portion and a second collecting portion, both the first collecting portion and the second collecting portion are capable of collecting data from the learning objects, wherein
the processor is configured with the program to perform operations such that operation as the modification instructing portion is further configured to modify the setting for operating the data collecting apparatus by operation as the operating portion, so that using the first collecting portion to collect the data is switched to using the second collecting portion to collect the data.

7. The learning data acquiring apparatus according to claim 3, wherein the data collecting apparatus comprises a first collecting portion and a second collecting portion, both the first collecting portion and the second collecting portion are capable of collecting data from the learning objects, and the first collecting portion and the second collecting portion perform an initialization operation of at least one selected from charging, preparing a storage space or setting collection parameters before collecting data from the learning objects, wherein
the processor is configured with the program to perform operations such that operation as the modification instructing portion is further configured to modify the setting for operating the data collecting apparatus by the operating portion, so that an initialization operation of the first collecting portion is switched to an initialization operation of the second collecting portion.

8. The learning data acquiring apparatus according to claim 3, wherein
the data collecting apparatus provides collected data to the input and output portion in one of a first communicating manner and a second communicating manner, and
the processor is configured with the program to perform operations such that operation as the modification instructing portion is further configured to modify the setting of the learning data acquiring portion, so that using the first communicating manner is switched to using the second communication manner.

9. The learning data acquiring apparatus according to claim 2, wherein
the processor is configured with the program to perform operations such that operation as the learning data acquiring portion further comprises operation as a managing portion configured to manage operation as the operating portion and operation as the input and output portion,
the learning condition information comprises a first learning condition information and a second learning condition information, and
the processor is configured with the program to perform operations such that operation as the modification instructing portion is further configured to modify the setting of the managing portion, so that acquiring the learning data according to the first learning condition information is switched to acquiring the learning data according to the second learning condition information.

10. The learning data acquiring apparatus according to claim 2, wherein
the processor is configured with the program to perform operations such that operation as the learning data acquiring portion further comprises operation as a managing portion configured to manage operation as the operating portion and operation as the input and output portion,
the learning condition information comprises information of programs for acquiring the learning data, and the programs comprise a first program and a second program, and
the processor is configured with the program to perform operations such that operation as the modification instructing portion is further configured to modify the setting of the managing portion, so that using the first program to acquire the learning data is switched to using the second program to acquire the learning data.

11. The learning data acquiring apparatus according to claim 1, wherein the processor is configured with the program to perform operations further comprising:
operation as a learning condition information generating portion, configured to receive from outside the learning condition information or generate the learning condition information according to the commission information, and send the learning condition information to operation as the learning data acquiring portion and operation as the modification instructing portion.

12. The learning data acquiring apparatus according to claim 1, wherein the processor is configured with the program to perform operations further comprising:
operation as a learning data storing portion configured to store the learning data.

13. A learning data acquiring method, configured to acquire learning data about learning objects for machine learning, comprising:
acquiring the learning data about the learning objects according to learning condition information, the learning condition information being information generated according to commission information of user commissioned learning; and
modifying setting for acquiring the learning data according to the learning condition information.

14. The learning data acquiring method according to claim 13, wherein acquiring the learning data about the learning objects comprises:
controlling an object operating apparatus performing an operation on the learning objects or a data collecting apparatus collecting data from the learning objects; and
receiving the data collected from the data collecting apparatus, and outputting the learning data generated according to the data.

15. The learning data acquiring method according to claim 14, wherein
the learning condition information comprises operation information about the object operating apparatus or the data collecting apparatus, and
modifying the setting for acquiring the learning data comprises: according to the operation information, modifying the setting for operating the object operating apparatus or the data collecting apparatus.

16. The learning data acquiring method according to claim 14, further comprises: receiving state information about the object operating apparatus or the data collecting apparatus, wherein
the learning condition information comprises operation information about the object operating apparatus or the data collecting apparatus, and
according to the operation information and the state information, modifying the setting for operating the object operating apparatus or the data collecting apparatus.

17. The learning data acquiring method according to claim 15, wherein the object operating apparatus comprises a first operating portion and a second operating portion, and both the first operating portion and the second operating portion are capable of operating the learning objects, wherein modifying the setting for operating the object operating apparatus comprises:
switching using the first operating portion to operate the learning objects to using the second operating portion to operate the learning objects.

18. The learning data acquiring method according to claim 15, wherein the data collecting apparatus comprises a first collecting portion and a second collecting portion, both the first collecting portion and the second collecting portion are capable of collecting data from the learning objects, wherein
modifying the setting for operating the data collecting apparatus comprises: switching using the first collecting portion to collect the data to using the second collecting portion to collect the data.

19. The learning data acquiring method according to claim 15, wherein the data collecting apparatus comprises a first collecting portion and a second collecting portion, both the first collecting portion and the second collecting portion are capable of collecting data from the learning objects, and the first collecting portion and the second collecting portion perform an initialization operation of at least one selected from charging, preparing a storage space or setting collection parameters before collecting data from the learning objects, wherein
modifying the setting for operating the data collecting apparatus comprises: switching an initialization operation of the first collecting portion to an initialization operation of the second collecting portion.

20. The learning data acquiring method according to claim 15, further comprises: receiving the collected data from the data collecting apparatus in one of a first communicating manner and a second communicating manner, wherein
modifying the setting for operating the data collecting apparatus comprises: switching using the first communicating manner to using the second communication manner.

21. The learning data acquiring method according to claim 13, wherein the learning condition information comprises a first learning condition information and a second learning condition information, wherein
modifying the setting for acquiring the learning data comprises: switching acquiring the learning data according to the first learning condition information to acquiring the learning data according to the second learning condition information.

22. The learning data acquiring method according to claim 13, wherein the learning condition information comprises information of programs for acquiring the learning data, and the programs comprise a first program and a second program, wherein
modifying the setting for acquiring the learning data comprises: switching using the first program to acquire the learning data to using the second program to acquire the learning data.

23. The learning data acquiring method according to claim 13, further comprises:
receiving the learning condition information; or
generating the learning condition information according to the commission information.

24. The learning data acquiring method according to claim 13, further comprises:
storing the learning data.

25. (canceled)

26. A non-transitory computer-readable storage medium storing a program for acquiring learning data about learning objects for machine learning, the program, when read and executed, causes a computer to perform operations comprising:
acquiring the learning data about the learning objects according to learning condition information, the learning condition information being information generated according to commission information of user commissioned learning; and
modifying setting for acquiring the learning data according to the learning condition information.
